(19) United States
(12) Patent Application Publication
(10) Pub. No.: US 2007/0077532 A1
(43) Pub. Date: Apr. 5, 2007

(54) Spherical drill bushing for installing a dental implant

(76) Inventor: Robert J. Harter, La Crosse, WI (US)

Correspondence Address: ROBERT J. HARTER, 4233 CLIFFSIDE DRIVE, LA CROSSE, WI, 54601, US

(21) Appl. No.: 11/634,682

(22) Filed: Dec. 6, 2006

Related U.S. Application Data
(62) Division of application No. 10/428,811, filed on May 2, 2003.

(51) Int. Cl. A61C 3/00

(52) U.S. Cl. 433/75

(57) ABSTRACT

A dental tool for guiding a drill bit during a dental implant procedure includes a drill bushing that is pivotally attached to a stent, wherein the drill bushing has a generally spherical surface that directly engages the stent.

### BACKGROUND OF THE INVENTION

1. Field of the Invention

The subject invention generally pertains to dental implants and more specifically to a tool for installing them.

2. Description of Related Art

Various dental implant methods and devices have been developed for replacing one or more missing teeth in a person's jaw with prosthetic teeth. For many prosthetic teeth, a final product comprises three basic components: an implant, an abutment, and a crown. The crown is the exposed portion of the prosthesis that resembles one or more teeth. The implant is an anchor that becomes attached to the jawbone, and the abutment couples the crown to the implant.

To install the implant, a hole is usually drilled into the patient's jawbone, and the implant is inserted into the hole.

A drill bushing attached to a stent can be used to help guide the drill bit, as disclosed in PCT Publication WO 99/26540 and U.S. Pat. Nos. 5,015,183; 5,133,660; 5,718,579. A drill bushing, unfortunately, can be difficult to attach to a stent, particularly if the drill bushing is to be pivotal relative to the stent as is the case in the U.S. Pat. No. 5,718,579 patent.

Thus, a need exists for a pivotal drill bushing that includes a feature for allowing the bushing to be readily attached to a stent.

### SUMMARY OF THE INVENTION

To attach a pivotal drill bushing to a surgical dental stent, it is an object of some embodiments of the invention to provide the bushing with a generally spherical surface that directly engages the stent.

Another object of some embodiments is to eliminate the need for a transitional piece between the bushing and the stent.

Another object of some embodiments is to create a ball-and-socket joint between a drill bushing and a stent.

Another object of some embodiments is to provide the ball-and-socket joint with an interference fit that prevents the drill bushing from pivoting too freely.

Another object of some embodiments to provide a drill bushing with pivotal freedom by press-fitting a spherical surface of the bushing into a cylindrical hole in a stent.

One or more of these and other objects of the invention are provided by a dental tool that includes a drill bushing pivotally attached to a stent, wherein the bushing has a generally spherical surface that directly engages the stent.

### BRIEF DESCRIPTION OF THE DRAWING

FIG. 1 is a perspective view showing stent being formed over a model jaw.

FIG. 2 is a perspective view showing the stent being removed from the model jaw.

FIG. 3 is a perspective view showing a drill bushing being inserted into a stent.

FIG. 4 is a cross-sectional view taken along line 4-4 of FIG. 5.

FIG. 5 is a perspective view showing a drill bit about to be inserted into a drill busing.

FIG. 6 is a cross-sectional view similar to FIG. 4 but showing the drill bit inserted into the drill bushing.

FIG. 7 is a cross-sectional view similar to FIG. 4 but of another embodiment.

FIG. 8 is a cross-sectional view similar to FIG. 8 but showing the pivoting freedom of the drill bushing.

FIG. 9 is a cross-sectional view similar to FIG. 7 but showing an alternate drill bushing.

FIG. 10 is a cross-sectional view similar to FIG. 8 but showing the drill bushing of FIG. 9.

FIG. 11 is a cross-sectional view similar to FIG. 7 but showing an alternate drill bushing.

FIG. 12 is a cross-sectional view similar to FIG. 8 but showing the drill bushing of FIG. 11.

FIG. 13 is a diagram showing how a “generally spherical surface” can curve at different radiuses about two perpendicular axes, wherein the radius of curvature about axis 64 is less than the radius of curvature about axis 66.

FIG. 14 is a perspective view of a drill bushing that has opposite facing flat surfaces.

### DESCRIPTION OF THE PREFERRED EMBODIMENT

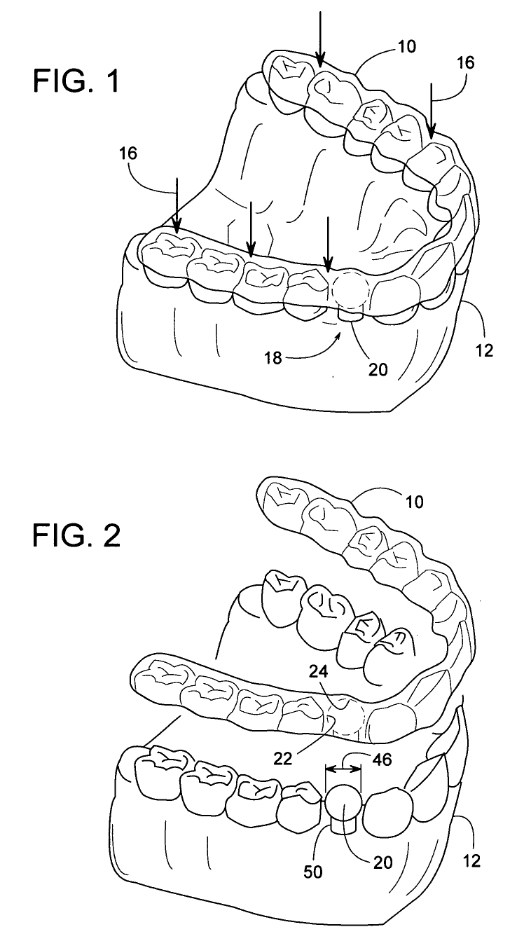

FIG. 1 shows a surgical dental stent 10 being formed over a model 12 of a patient's actual upper or lower jaw 14 (FIG. 5). Model 12 can be cast or otherwise made in a conventional manner well known to those skilled in the art. The term, “jaw” refers to that part of a patient's body that comprises one or more of the following: teeth, gums, and/or jawbone (upper or lower). Stent 10 is a conventional surgical dental stent that can be produced in various ways that are well known to those skilled in the art. Arrows 16 schematically represent a vacuum forming process as well as other common methods of making a stent. Stent 10 can be hollow or solid in an area 18 of the missing tooth.

In some cases, a plug 20 is placed on model 12 in the area of the missing tooth to create a concavity 22 in stent 10 as stent 10 is being formed. Concavity 22 preferably has a substantially spherical concave surface 24; however other surface shapes are possible.

FIG. 2 shows stent 10 with concavity 22 being lifted from model 12.

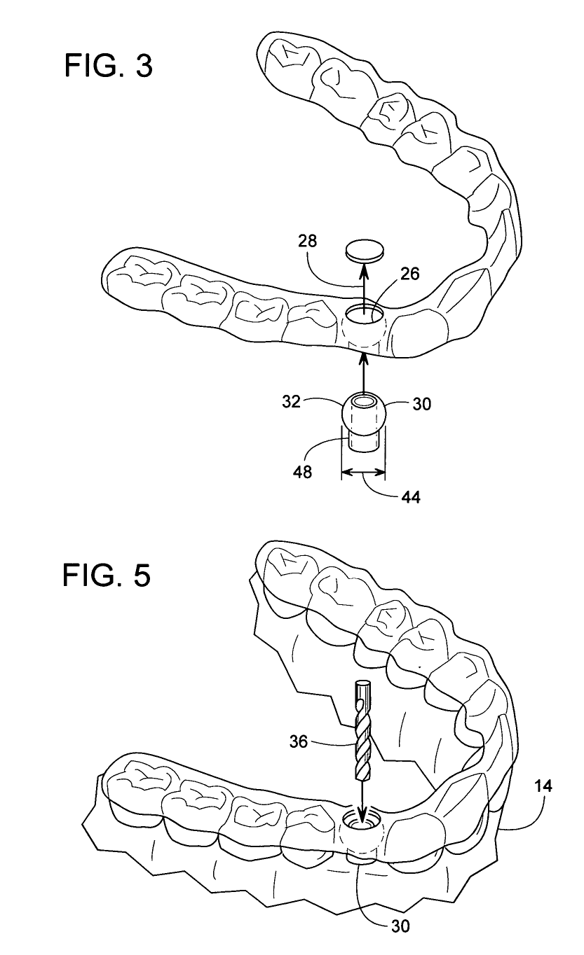

A hole 26, which is in area 18 of the missing tooth, can be created in stent 10 by various methods including, but not limited to, drilling, punching, cutting, etc. This step is represented by arrow 28 of FIG. 3.

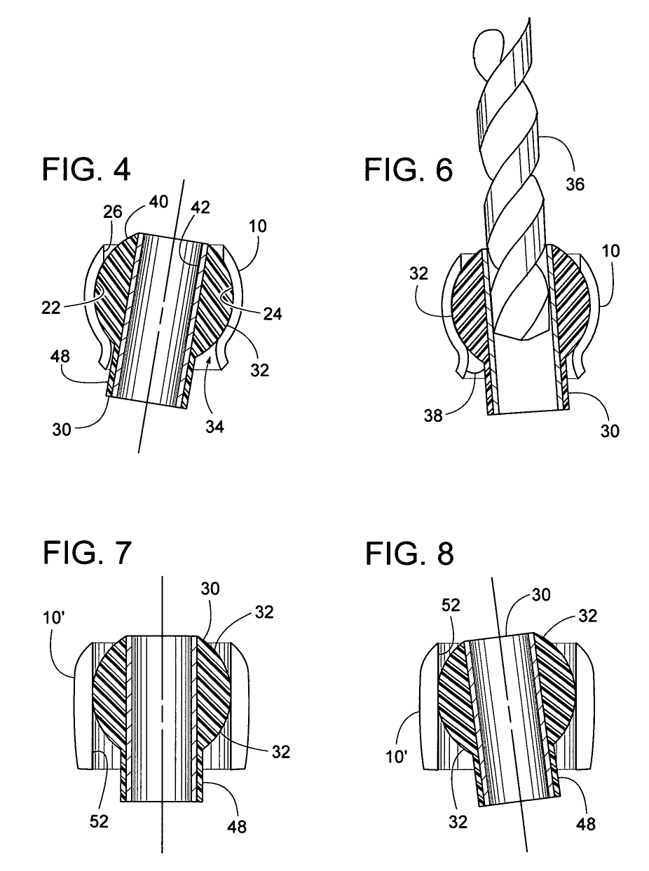

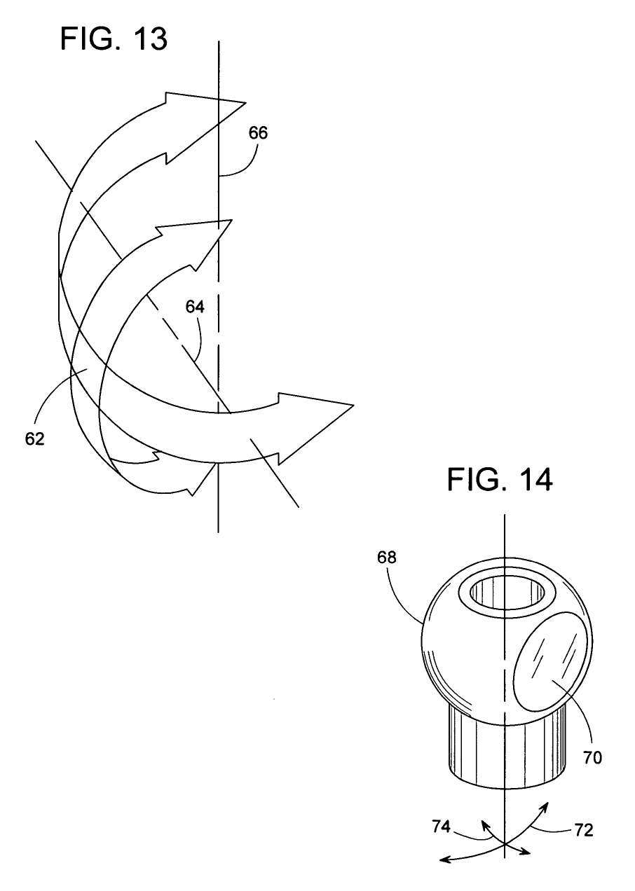

Also shown in FIG. 3 is a dental tool or drill bushing 30 being inserted into the concavity of stent 10. Bushing 30 has a generally spherical surface 32 that when inserted into concavity 22 creates a ball-and-socket joint 34 between bushing 30 and stent 10, as shown in FIG. 4. The term, “generally spherical,” as used herein and throughout, refers to any surface that curves about two axes that are at right angles to each other, which includes but is not limited to purely spherical surfaces. Although the radii of curvature of about each axis are preferably equivalent, that does not necessarily have to be the case. In FIG. 13, for example, generally spherical surface 62 curves about axes 64 and 66, wherein axes 64 and 66 are perpendicular to each other, but they do not necessarily intersect. Referring to FIGS. 5 and 6, joint 34 allows bushing 30 to pivot relative to stent 10, whereby bushing 30 can help aim and guide a drill bit 36 directly into jaw 14. Once drill bushing 30 is aimed in the right direction, a bonding material 38 can be used to affix bushing 30 to stent 10. In some cases, bushing 30 may comprise a plastic body 40 with a metal sleeve 42; however, drill bushings made entirely of plastic or entirely of metal are also well within the scope of the invention.

During the period of adjusting the angular position of bushing 30 relative to stent 10, bushing 30 can be prevented from pivoting too freely within stent 10 by providing joint 34 with an interference fit between bushing 30 and stent 10. Such an interference fit is readily achieved by providing bushing 30 with an outside diameter 44 that is slightly larger than an outside diameter 46 of plug 20.

To ensure sufficient clearance between bushing 30 and the gum tissue of jaw 12, a stub portion 48 of bushing 30 is preferably slightly shorter than a corresponding stub portion 50 of plug 20.

In cases where a stent 10 is generally solid in the area of the missing tooth, thereby precluding the use of plug 20, bushing 30 can be inserted into a hole 52 drilled into stent 10′, as shown in FIGS. 7 and 8. The size of hole 52 is preferably smaller than the outside diameter 44 of bushing 30 to create an interference fit between bushing 30 and stent 10′, yet spherical surface 32 still allows bushing 30 to pivot within hole 52. Once bushing 30 is pivoted to a desired orientation, bonding material 38 can affix bushing 30 to stent 10′.

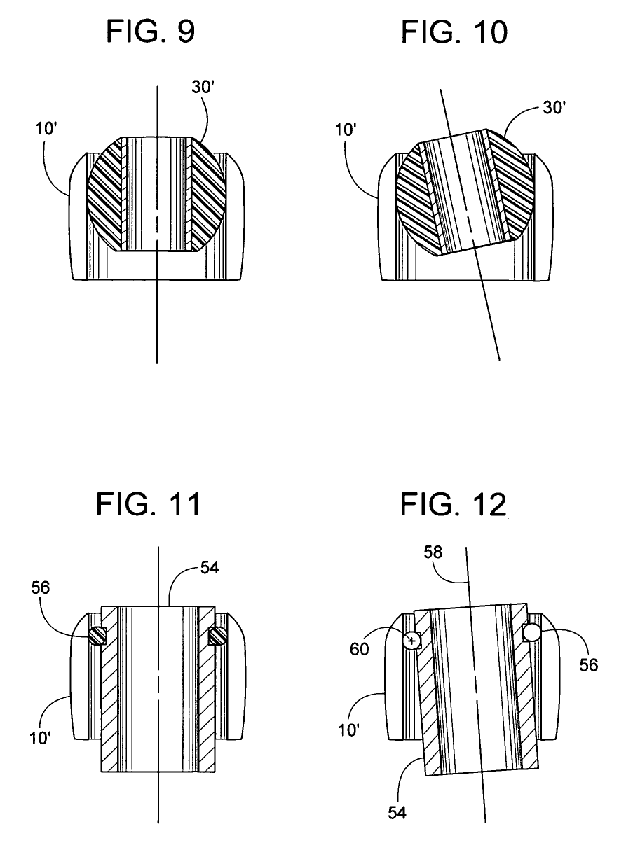

In some cases, a drill bushing 30′ may not have a stub portion 48 as shown in FIGS. 9 and 10.

In FIGS. 11 and 12, a drill bushing 54 includes an O-ring 56 that provides an interference fit between bushing 54 and stent 10′. The entire drill bushing, including O-ring 56 can pivot within stent 10′. O-ring 56 provides a generally spherical surface in that the surface curves about axis 58 and curves around an axes 60 or annular centerline that runs through the center of the O-ring.

Once bushing 30′ or 54 are aimed in the desired direction, the bushings can be bonded to stent 10′

Referring to FIG. 14, in cases where a missing tooth leaves a very limited space between two existing teeth, a modified drill bushing 68 (and similarly modified plug) can be used instead of bushing 30. Bushing 68 is similar to bushing 30 except that bushing 68 has two opposite-facing flat surfaces 70 that can be positioned to face the two existing teeth. A plug for bushing 68 could be similar to plug 20 but with two flat surfaces corresponding to surfaces 70. Due to flat surfaces 70, bushing 30 has greater freedom within a stent to pivot in one direction 72 than in another direction 74 perpendicular thereto.

Although the invention is described with reference to a preferred embodiment, it should be appreciated by those skilled in the art that various modifications are well within the scope of the invention. Therefore, the scope of the invention is to be determined by reference to the following claims.

1-9. (canceled)

10. A dental tool method for guiding a drill bit relative to a jaw of a patient, the method comprising:
forming a stent about a plug to create a concavity in the stent;
providing a drill bushing with a generally spherical surface, wherein the drill bushing is adapted to guide the drill bit into the jaw;
removing the plug from the stent; and
inserting the drill bushing into the concavity such that the generally spherical surface of the drill bushing engages the stent.

11. The method of claim 10, further comprising pivoting the drill bushing relative to the stent.

12. The method of claim 10, further comprising creating an interference fit between the stent and the generally spherical surface of the drill bushing.

13. The method of claim 10, wherein the concavity includes a substantially spherical concave surface.
